(19) United States
(12) Patent Application Publication
(10) Pub. No.: US 2026/0331347 A1
(43) Pub. Date: Oct. 22, 2026

(54) MAGNETIZER FOR A RING MAGNET

(71) Applicant: Boston Dynamics, Inc., Waltham, MA (US)

(72) Inventor: Steven Potter, Waltham, MA (US)

(73) Assignee: Boston Dynamics, Inc., Waltham, MA (US)

(21) Appl. No.: 19/410,485

(22) Filed: Dec. 5, 2025

Related U.S. Application Data
(60) Provisional application No. 63/740,212, filed on Dec. 30, 2024.

(51) Int. Cl. H01F 13/00; H01F 5/04; H01F 41/10

(52) U.S. Cl. CPC H01F 13/003; H01F 41/10; H01F 5/04

(57) ABSTRACT

A magnetizer for magnetizing a ring magnet is provided. The magnetizer includes a set of capacitors and a core including a set of teeth, a set of coils arranged on the set of teeth, a set of conductors, each conductor in the set of conductors being electrically coupled to a coil in the set of coils, and a set of switches electrically coupled between a conductor in the set of conductors and one or more capacitors in the set of capacitors, wherein each switch in the set of switches is configured to be controlled independently of other switches in the set of switches.

### CROSS-REFERENCE TO RELATED APPLICATIONS

This application claims the benefit under 35 U.S.C. § 119(e) of U.S. Provisional application Ser. No. 63/740,212, filed Dec. 30, 2024, and entitled, “MAGNETIZER FOR A RING MAGNET,” the entire contents of which is incorporated herein by reference.

### FIELD OF THE INVENTION

This disclosure relates generally to techniques for magnetizing a ring magnet.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

A variety of settings today demand high levels of automation, e.g., factories, transportation facilities, material handling facilities and warehouses, among others. At least some of the automation in such environments may be provided by robots that can perform tasks, such as moving objects (e.g., automobile parts) from a first location to a second location (e.g., a so-called “pick and place” operation), lifting heavy objects, etc. While certain types of tasks in such environments may be performed by robots mounted at a fixed location or mobile wheeled robots, other tasks may be more well-suited for robots with legs. Humanoid robots may be legged robots that include components (e.g., feet, arms, torso, head, hands) modeled after the human form with members connected by joints that enable the members to rotate with one or more degrees of freedom about the joint. Quadruped robots may be legged robots that include components modeled after non-human animal forms with members similarly connected by joints.

Robots employ actuators to move their appendages. Actuators can account for a large portion of the overall cost of the robot, and the capability, agility and payload capacity of a robot often depends, at least in part, on the actuators' performance. Geared electric motors are frequently used as actuators in robots. The gearing enables the motor to operate at higher speeds and generate low torque, thereby providing higher power output with less mass and lower losses. An electric motor includes magnetic structures (e.g., an array of permanent magnets), which enable the different portions of the motor to rotate relative to one another to generate power. The inventors have recognized and appreciated that due, at least in part, to limitations of some conventional magnetizers, the magnetic structures used inside some conventional electric motors are not magnetized strongly enough to provide sufficient torque per mass required to perform athletic maneuvers and/or execution of various tasks (e.g., lifting and walking with heavy objects) a robot may be expected to perform in a warehouse environment. To this end, some embodiments relate to a magnetizer configured to magnetize a magnetic structure (e.g., a polar anisotropic ring magnet) that may be used in a motor architecture for a robot that enables high peak torque.

In some embodiments, the invention features a magnetizer for magnetizing a ring magnet. The magnetizer includes a set of capacitors, a core comprising a set of teeth, a set of coils arranged on the set of teeth, a set of conductors, each conductor in the set of conductors being electrically coupled to a coil in the set of coils, and a set of switches electrically coupled between a conductor in the set of conductors and one or more capacitors in the set of capacitors, wherein each switch in the set of switches is configured to be controlled independently of other switches in the set of switches.

In one aspect, the set of switches comprises a set of thyristors. In another aspect, the set of conductors comprises a set of busbars. In another aspect, the magnetizer further includes a controller configured to activate each switch in the set of switches at substantially a same time. In another aspect, activating the switch electrically couples the one or more coupled capacitors in the set of capacitors coupled thereto to its corresponding coil in the set of coils.

In another aspect, the core comprises a laminated metal. In another aspect, a number of coils in the set of coils is half of a number of teeth in the set of teeth. In another aspect, the set of coils are arranged on alternating teeth in the set of teeth. In another aspect, the set of coils are potted into slots of the core between the set of teeth using an epoxy. In another aspect, each coil in the set of coils comprises flat copper wire. In another aspect, at least one coil in the set of coils has a trapezoidal shape in cross-section.

In another aspect, the core comprises a set of segments, and each segment of the set of segments includes at least one coil in the set of coils. In another aspect, a first segment of the set of segments includes at least two coils electrically coupled in series. In another aspect, each segment of the set of segments includes a single coil of the set of coils and is associated with a single capacitor of the set of capacitors. In another aspect, each segment of the set of segments includes a single coil of the set of coils and is configured to magnetize a portion of a ring magnet having more than one pole when present in the magnetizer. In another aspect, a number of segments in the set of segments is half of a number of poles included in a ring magnet configured to be magnetized by the magnetizer. In another aspect, the set of capacitors are electrically coupled in parallel. In another aspect, the core further comprises a cooling device configured to cool the set of coils. In another aspect, the core is ring-shaped.

In some embodiments, the invention features a method of magnetizing a ring magnet using a magnetizer. The method includes magnetizing a set of arc-segments of a ring magnet when the ring magnet is arranged in the magnetizer. Magnetizing the set of arc-segments includes simultaneously activating a set of switches to deliver a pulse of current through a set of coils of the magnetizer, each switch in the set of switches being coupled to a respective coil in the set of coils to form an independently controllable circuit including the switch and the coil. In one aspect, the set of switches are electrically coupled to a set of charged capacitors, and activating the set of switches results in the pulse of current being transferred from the set of charged capacitors to a respective coil in the set of coils. In another aspect, the set of switches comprises a set of thyristors.

In another aspect, the method further includes pressing magnetic powder in a fixture in a presence of a magnetic field to generate a green compact having magnetic grains aligned in a desired magnetic flux pattern, sintering the green compact to form a hardened ring magnet, and orienting the hardened ring magnet in the magnetizer based on the alignment of the magnetic grains in the hardened ring magnet and a configuration of the magnetizer. In another aspect, orienting the hardened ring magnet in the magnetizer comprises magnetizing the hardened ring magnet to a first field strength in a first magnetization fixture to generate a first magnetized ring magnet having the desired magnetic flux pattern, and placing the first magnetized ring magnet in a second magnetization fixture configured to magnetize the first magnetized ring magnet to a second field strength greater than the first field strength, wherein the orienting of the hardened ring magnet in the magnetizer is facilitated by the magnetic flux pattern of the first magnetized ring magnet and a configuration of the second magnetization fixture. In another aspect, the first magnetization fixture and/or the second magnetization fixture comprises a Halbach array fixture. In another aspect, orienting of the hardened ring magnet in the magnetizer is further facilitated by dithering a position of the first magnetized ring magnet within the second magnetization fixture.

In another aspect, a number of segments in the set of arc-segments is half of a number of poles included in the ring magnet. In another aspect, the method further includes cooling, with a cooling device, the set of coils following simultaneously activating a set of switches to deliver a pulse of current through the set of coils of the magnetizer. In another aspect, magnetizing the set of arc-segments comprises magnetizing the set of arc-segments such that the magnetic material at an inner diameter of the ring magnet is magnetized to at least 2.5 Tesla.

In some embodiments, the invention features a method of manufacturing a magnetizer for magnetizing a ring magnet. The method includes electrically coupling a set of coils arranged on a set of teeth of a core to a set of capacitors via a set of conductors and a set of switches, wherein each conductor in the set of conductors is electrically coupled to a coil in the set of coils, each switch in the set of switches is electrically coupled between a conductor in the set of conductors and one or more capacitors in the set of capacitors, and each switch is independently controllable such that current is provided from the one or more capacitors coupled to the switch to an individual conductor in the set of conductors.

In one aspect, the set of switches comprises a set of thyristors. In another aspect, the set of conductors comprises a set of busbars. In another aspect, the method further includes configuring a controller to activate each switch in the set of switches at substantially a same time. In another aspect, activating the switch electrically couples one or more charged capacitors in the set of capacitors to a corresponding coil in the set of coils.

In another aspect, the method further includes forming the core from a laminated metal. In another aspect, the method further includes arranging the set of coils on the set of teeth, wherein a number of coils in the set of coils is half of a number of teeth in the set of teeth. In another aspect, arranging the set of coils on the set of teeth comprises arranging the set of coils on alternating teeth in the set of teeth. In another aspect, the method further includes potting the set of coils into slots of the core between the set of teeth using an epoxy. In another aspect, the method further includes forming each coil in the set of coils from flat copper wire. In another aspect, forming each coils in the set of coils from flat copper wire comprises forming at least one coil in the set of coils to have a trapezoidal shape in cross-section.

In another aspect, the core comprises a set of segments, and the method further comprises arranging at least one coil in the set of coils in each segment of the set of segments. In another aspect, arranging at least one coil in the set of coils in each segment of the set of segments comprises arranging in a first segment of the set of segments at least two coils electrically coupled in series. In another aspect, each segment of the set of segments includes a single coil of the set of coils and is associated with a single capacitor of the set of capacitors. In another aspect, each segment of the set of segments includes a single coil of the set of coils and is configured to magnetize a portion of a ring magnet having more than one pole when present in the magnetizer. In another aspect, a number of segments in the set of segments is half of a number of poles included in a ring magnet configured to be magnetized by the magnetizer.

In another aspect, the method further includes electrically coupling the set of capacitors in parallel. In another aspect, the method further includes arranging a cooling device proximate to the set of coils, wherein the cooling device is configured to cool the set of coils. In another aspect, the method further includes forming the core as a ring-shaped structure.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1 shows an example configuration of a robotic device, according to an illustrative embodiment of the invention.

FIG. 2A shows an example of a humanoid robot, according to an illustrative embodiment of the invention.

FIG. 2B shows an example of various actuators of a humanoid robot, according to an illustrative embodiment of the invention.

FIG. 3A schematically shows a magnetizer assembly, according to an illustrative embodiment of the invention.

FIG. 3B schematically shows a magnetizing fixture for use in a magnetizer assembly, according to an illustrative embodiment of the invention.

FIG. 3C schematically shows a thyristor as an example of a type of switch that may be used in a magnetizer assembly, according to an illustrative embodiment of the invention.

FIG. 3D is a block diagram of some components of a magnetizer assembly, according to an illustrative embodiment of the invention.

FIG. 4 schematically illustrates a cross section through a portion of a magnetizing fixture and a portion of a ring magnet during magnetization of the ring magnet by the magnetizing fixture, according to an illustrative embodiment of the invention.

FIG. 5 is flowchart of a process for magnetizing a ring magnet using a magnetizer assembly, according to an illustrative embodiment of the invention.

FIG. 6 is a flowchart of a process for manufacturing a magnetizer assembly, according to an illustrative embodiment of the invention.

### DETAILED DESCRIPTION

The performance of motors/actuators in robotic devices is often a large driver of overall robot performance. Humanoid and quadruped robots include a number of actuators (e.g., 2-5 actuators) coupled to members of a robotic limb that facilitate movement of the robotic limb through a range of motion limited by the joints connecting the members. To achieve a desired level of athletic performance, the actuators of a robot may require a high peak torque output in a lightweight and compact form factor (e.g., small diameter).

Electric motors used in robot applications include a stator configured to generate a magnetic field and a rotor configured to rotate relative to the stator to generate torque. In some embodiments the rotor includes a magnetic structure comprising one or more permanent magnets. For instance, the magnetic structure may be implemented as a multi-pole Halbach ring magnet (e.g., including NdFeB or other rare-earth magnets). Such a multi-pole Halbach ring magnet produces a magnetic field having a magnetic flux density (field strength) that is greater on one side of the magnet (e.g., the outside surface for use in an inrunner electric motor, the inside surface for use in an outrunner electric motor), resulting in a magnetic structure having a field strength that surpasses that of an identical radial-anisotropic (radially magnetized ring magnet). Such a multi-pole Halbach ring magnet may be implemented, for example, as a bonded/segmented Halbach array design or a polar anisotropic ring magnet. Although the example magnetic structures described herein are shown with the outer diameter being the “strong side” and the inner diameter being the “weak side,” (e.g., for use in an inrunner electric motor) it should be appreciated that other embodiments may be implemented with the inner diameter being the “strong side” and the outer diameter being the “weak side” (e.g., for use in an outrunner electric motor.

Some conventional techniques for creating a multi-pole Halbach ring magnet includes fabricating many small arc-segment magnets with varying magnetic alignment, then bonding (e.g., gluing) the magnets to a substrate, such as a tube made of aluminum, fiber-reinforced plastic (FRP) or other structural material. In some robotic operations, having a magnetic structure with a high number of poles may be advantageous. However, assembling a multi-pole Halbach ring magnet by bonding many small arc-segment magnets to a substrate is challenging due to the high parts count (e.g., large number of magnet segments), fragility of the magnet segments, and labor intense assembly/bonding process. The assembly process may be simplified by bonding demagnetized magnetic material to the substrate, followed by magnetizing the magnets in the array once bonded. However, magnetizing a demagnetized multi-pole Halbach ring magnet can be challenging with conventional magnetizers. As an alternative to the assembly process for a segmented Halbach ring magnet as discussed above, a polar anisotropic ring magnet may be fabricated and magnetized to approximate an “ideal Halbach” array. When fabricated with a high number of poles, the magnet (or magnet assembly) may be thick relative to the pole spacing, such that an extremely high current density in the magnetizing fixture may be required to magnetize the magnetic material at the “weak side” of the magnet to achieve sufficient flux density for adequate magnetization of the weak side of the magnet (e.g., 3T). When using such high currents, the current pulse used for magnetization may also need to be short (e.g., 20-50 μs) to avoid overheating the coils in the magnetizer. To this end, some embodiments of the present disclosure relate to a magnetizer configured to magnetize a multi-pole Halbach ring magnet (e.g., a polar anisotropic ring magnet) by simultaneously magnetizing individual arc-segments of the magnet. Segmentation of the magnetizer may reduce the capacitance and inductance associated with each arc-segment and/or may increase the natural frequency of the system allowing for a higher amplitude current pulse without overheating the coil(s) during magnetization of a magnet using the magnetizer.

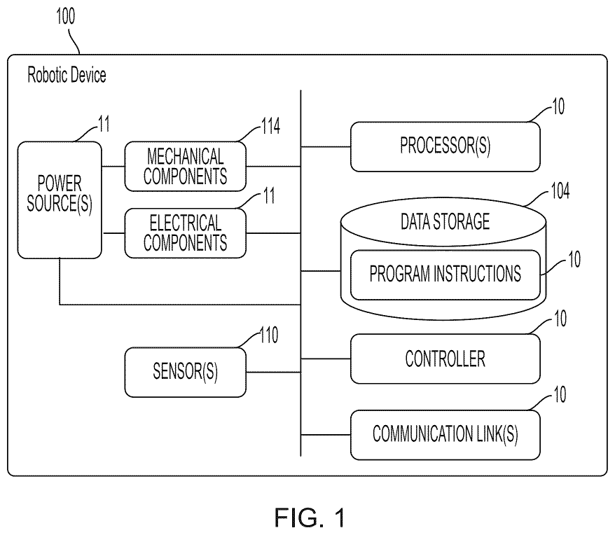

Referring now to the figures, FIG. 1 illustrates an example configuration of a robotic device (or “robot”) 100, according to an illustrative embodiment of the invention. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic device 100 and a user(s).

The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic device 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic device 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic device 100 may connect to multiple power sources as well.

Within example configurations, any type of power source may be used to power the robotic device 100, such as a gasoline and/or electric engine. Further, the power source(s) 112 may charge using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100.

Mechanical components 114 can represent hardware of the robotic device 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The mechanical components 114 may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, providing electrical charge or electric signals, for example.

Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information read in by sensor(s) 110 may be transmitted via the communication link(s) 118 to a separate device. Other diagnostic information indicating the integrity or health of the power source(s) 112, mechanical components 114, electrical components 116, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 or the electrical components 116. In some cases, the received information indicates a query requesting a particular piece of information (e.g., the operational state of one or more of the components of the robotic device 100), and the processor(s) 102 may subsequently transmit that particular piece of information back out the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

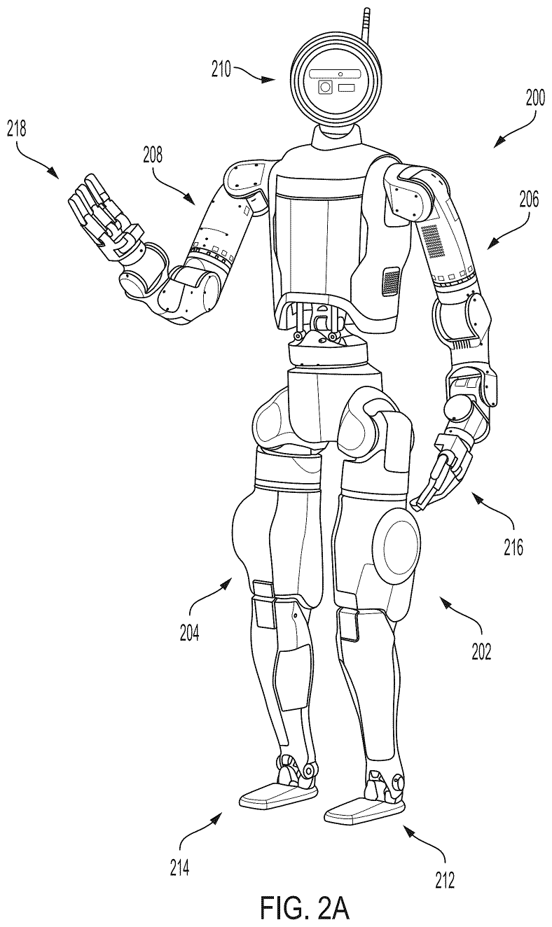

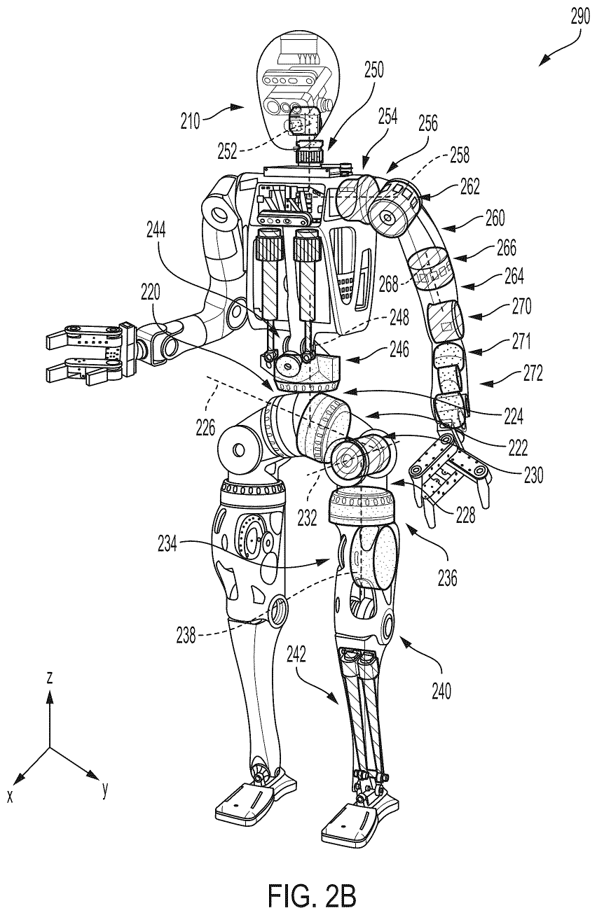

FIG. 2A illustrates an example of a humanoid robot, according to an illustrative embodiment of the invention. The robot 200 may correspond to the robotic device 100 shown in FIG. 1. The robot 200 serves as a possible implementation of a robotic device that may be configured to include the systems and/or carry out the methods described herein. Other example implementations of robotic devices may exist.

The robot 200 may include a number of articulated appendages, such as robotic legs 202, 204 and/or robotic arms 206, 208. The robot 200 may also include a robotic head 210, which may contain one or more vision sensors (e.g., cameras, infrared sensors, object sensors, range sensors, etc.). Each articulated appendage may include a number of (e.g., one, two, three or more) members connected by joints that allow the articulated appendage to move through certain degrees of freedom. For example, each robotic leg 202, 204 may include a respective foot 212, 214, which may contact a surface (e.g., a ground surface). The legs 202, 204 may enable the robot 200 to travel at various speeds according to various gaits. In addition, each robotic arm 206, 208 may facilitate object manipulation, load carrying, and/or balancing of the robot 200. Each arm 206, 208 may also include one or more members connected by joints and may be configured to operate with various degrees of freedom. Each arm 206, 208 may also include a respective end effector (e.g., gripper, hand, etc.) 216, 218. The robot 200 may use end effectors 216, 218 for interacting with (e.g., gripping, turning, pulling, and/or pushing) objects. Each end effector 216, 218 may include various types of appendages or attachments, such as fingers, attached tools or grasping mechanisms. In some embodiments, one or more sensors (e.g., cameras, infrared sensors, object sensors, range sensors, etc.) may be arranged on an arbitrary member or link of the robot.

Robot 200 may also include sensors to measure the angles of the joints of its articulated appendages. In addition, the articulated appendages may include a number of actuators that can be controlled to extend and retract members of the articulated appendages. Examples of actuators that may be included in robot 200 are described in more detail in FIG. 2B. In some cases, the angle of a joint may be determined based on the extent of protrusion or retraction of a given actuator. In some instances, the joint angles may be inferred from position data of inertial measurement units (IMUs) mounted on the members of an articulated appendage. In some implementations, the joint angles may be measured using rotary position sensors, such as rotary encoders. In other implementations, the joint angles may be measured using optical reflection techniques. Other joint angle measurement techniques may also be used.

In some embodiments, robot 200 may include a set of continuous rotation joints, where each continuous rotation joint permits continuous (e.g., 360 degree and/or limitless) rotation about a corresponding axis. Rather than requiring such joints to “unwind” by, for example, always determining a target joint angle relative to a nominal (e.g., 0 degree) orientation, a control system of the robot 200 may be configured to determine that the target joint angle be set at any multiple of 360 degrees (e.g., 0 degrees, 360 degrees, 720 degrees) to permit efficient movement of an attached member about the joint to achieve the target joint angle. For instance, if a target joint angle of a continuous rotation joint is 15 degrees and the current joint angle is 350 degrees, rather that rotating an attached member −335 degrees about the joint, the attached member can instead be rotated +25 degrees (to 375 degrees), which is equivalent to a joint angle of 15 degrees for a continuous rotation joint.

In some embodiments, robot 200 may include a body (e.g., a torso and a base such as a pelvis base) and one or more kinematic chains of robot members (e.g., arms, legs) coupled to the body. Each of the plurality of kinematic chains of robot members may include at least two joints (e.g., a first joint coupling the kinematic chain to the body and a second joint coupling at least two members of the kinematic chain). At least one of the at least two joints in a kinematic chain may be a continuous rotation joint that enables continuous rotation of at least one of the members (and possibly all members if the joint that couples the kinematic member to the body is a continuous rotation joint) of the kinematic chain about the joint.

Robot 200 may be configured to send sensor data from the articulated appendages to a device coupled to robot 200 such as a processing system, a computing system, or a control system. Robot 200 may include a memory, either included in a device on robot 200 or as a standalone component, on which sensor data is stored. In some implementations, the sensor data is retained in the memory for a certain amount of time. In some cases, the stored sensor data may be processed or otherwise transformed for use by a control system on robot 200. In some cases, robot 200 may also transmit the sensor data over a wired or wireless connection (or other electronic communication means) to an external device.

FIG. 2B illustrates an example of a humanoid robot 290, according to an illustrative embodiment of the invention. Humanoid robot 290 may include components (e.g., arms, legs, feet, head) similar to robot 200 of FIG. 2A, which may not be relabeled in FIG. 2B to reduce clutter. Overlaid on the depiction of humanoid robot 290 are a set of actuators that may be used to move an attached member at corresponding joints of the humanoid robot 290 to enable movement of the robot. As described in more detail below, humanoid robot 290 may include different types of actuators and joints that enable different members of the robot to move with varying degrees of freedom, permitting flexibility of movement when desired while restricting movement as appropriate to, for example, avoid or reduce the risk of collisions between robot components.

Humanoid robot 290 includes a base member (e.g., a pelvis base, as shown in FIG. 2B) 220. The pelvis base 220 is rotatably connected to a first hip member 222. An electric actuator 224 may be disposed between the pelvis base 220 and the first hip member 222 (e.g., in, between, connected to, and/or as part of one or both components). In some embodiments, a first portion of the electric actuator 224 may be fixed to the pelvis base 220, and a second portion of the electric actuator 224 may be fixed to the first hip member 222. The electric actuator 224 may be configured to rotate the pelvis base 220 relative to the first hip member 222 about an axis (e.g., a first hip-y axis) 226. The first hip member 222 is also connected to a first intermediate leg member 228. An electric actuator 230 may be disposed between the first hip member 222 and the first intermediate leg member 228 (e.g., in, between, connected to, and/or as part of one or both components). In some embodiments, a first portion of the electric actuator 230 may be fixed to the first hip member 222, and a second portion of the electric actuator 230 may be fixed to the first intermediate leg member 228. The electric actuator 230 may be configured to rotate the first hip member 222 relative to the first intermediate leg member 228 about an axis (e.g., a first hip-x axis) 232. The first intermediate leg member 228 is also connected to a first leg member 234. An electric actuator 236 may be disposed between the first intermediate member 228 and the first leg member 234 (e.g., in, between, connected to, and/or as part of one or both components). In some embodiments, a first portion of the electric actuator 236 may be fixed to the first intermediate member 228, and a second portion of the electric actuator 236 may be fixed to the first leg member 234. The electric actuator 236 may be configured to rotate the first intermediate leg member 228 relative to the first leg member 234 about an axis (e.g., a first hip-z axis) 238. In some embodiments, a second hip member, second intermediate leg member, and second leg member are connected in similar fashion to the first hip member, first intermediate leg member, and first leg member, using similar actuators rotating along similar additional axes and/or providing similar independently actuatable degrees of freedom.

The axis 226 may be referred to as a first hip-y axis, which denotes a flexion/extension axis of the robot 200. The axis 232 may be referred to as a first hip-x axis, which denotes an abduction/adduction axis. The axis 238 may be referred to as a first hip-z axis, which denotes a pronation/supination axis. FIG. 2B shows a set of reference axes to illustrate the x, y and z directions, although the actual x, y, and z axes in the robot 200 need not be mutually orthogonal or extend from the same origin. In some embodiments, rotation about the first hip-y axis 226 may cause the robot leg 202 to swing upward and backward (e.g., in a direction that would enable the robot 200 to walk forward and backward). In some embodiments, rotation about the first hip-x axis 232 may cause the robot leg 202 to swing inward (e.g., toward a center line between the legs 202, 204 of the robot 200) and outward. In some embodiments, rotation about the first hip-z axis may cause the robot leg 202 to rotate the stance of the leg (e.g., twist it to the left or to the right). In some embodiments, the leg member 234 is an upper leg member, which may in turn be connected to a lower leg member 242 at a knee joint 240. In some embodiments, the lower leg member 242 is connected to a foot (e.g., foot 212) at an ankle joint.

In some embodiments, the pelvis base 220 is rotatably connected and/or configured to be rotatably connected to a back member 244 (also referred to herein as a “torso”) of the robot 290. An electric actuator 246 may be disposed between the pelvis base 220 and the back member 244 (e.g., in, between, connected to, and/or part of one or both components). In some embodiments, a first portion of the electric actuator 246 may be fixed to the pelvis base 220, and a second portion of the electric actuator 246 may be fixed to the back member 244. The electric actuator 246 may be configured to rotate the back member 244 relative to pelvis base 220 about an axis (e.g., back-z axis) 248. In some embodiments, the back member 244 is rotatably connected and/or configured to be rotatably connected to a head 210 of the robot 290. An electric actuator 250 may be disposed between the back member 244 and the head 210 (e.g., in, between, connected to, and/or part of one or both components). In some embodiments, a first portion of the electric actuator 250 may be fixed to the head 210 and a second portion of the electric actuator 250 may be fixed to the back member 244. The electric actuator 250 may be configured to rotate the head 210 relative to the back member 244 about an axis (e.g., neck-z axis) 252.

In some embodiments, a first shoulder member 256 is rotatably connected and/or configured to be rotatably connected to a back member 244 of the robot 290. An electric actuator 254 may be disposed between the back member 244 and the first shoulder member 256 (e.g., in, between, connected to, and/or part of one or both components). In some embodiments, a first portion of the electric actuator 254 may be fixed to the first shoulder member 256, and a second portion of the electric actuator 254 may be fixed to the back member 244. The electric actuator 254 may be configured to rotate the first shoulder member 256 relative to the back member 244 about an axis (e.g., shoulder-y axis) 258. In some embodiments, the first shoulder member 256 is rotatably connected and/or configured to be rotatably connected to a first intermediate arm member 260 of the robot 290. An electric actuator 262 may be disposed between the first shoulder member 256 and the first intermediate arm member 260 (e.g., in, between, connected to, and/or part of one or both components). In some embodiments, a first portion of the electric actuator 262 may be fixed to the first intermediate arm member 260, and a second portion of the electric actuator 262 may be fixed to the first shoulder member 256. The electric actuator 262 may be configured to rotate the first intermediate arm member 260 relative to the first shoulder member 256 about an axis to provide adduction/abduction of the first intermediate arm member 260 relative to the first shoulder member 256. In some embodiments, a first upper arm member 264 is rotatably connected and/or configured to be rotatably connected to the first intermediate arm member 260 of the robot 290. An electric actuator 266 may be disposed between the first arm member 264 and the first intermediate arm member 260 (e.g., in, between, connected to, and/or part of one or both components). In some embodiments, a first portion of the electric actuator 266 may be fixed to the first arm member 264, and a second portion of the electric actuator 266 may be fixed to the first intermediate arm member 260. The electric actuator 266 may be configured to rotate the first arm member 264 relative to the first intermediate arm member 260 about an axis (e.g., shoulder-z axis) 268.

In some embodiments, the first arm member 264 may in turn be connected to a first lower arm member 272 at a first elbow joint. An electric actuator 270 may be disposed between the first arm member 264 and the first lower arm member 272 (e.g., in, between, connected to, and/or part of one or both components). In some embodiments, a first portion of the electric actuator 270 may be fixed to the first arm member 264, and a second portion of the electric actuator 270 may be fixed to the first lower arm member 272. The electric actuator 270 may be configured to rotate the first arm member 264 relative to the first lower arm member 272 about an axis that provides flexion/extension of the first lower arm member 272 relative to the first arm member 264. In some embodiments, rotation about the first elbow joint may be greater than 90 degrees. In some embodiments, rotation about the first elbow joint may be greater than 180 degrees.

In some embodiments, the first lower arm member 272 is connected to an end effector (e.g., a gripper or hand) via a wrist component. The wrist component may contain one or more actuators configured to provide various ranges of motion to the wrist of the robot. In some embodiments, a second shoulder member, second intermediate arm member, second upper arm member, and second lower arm member are connected in similar fashion to the first shoulder member, first intermediate arm member, first upper arm member, and first lower arm member using similar actuators rotating along similar additional axes and/or providing similar independently actuatable degrees of freedom.

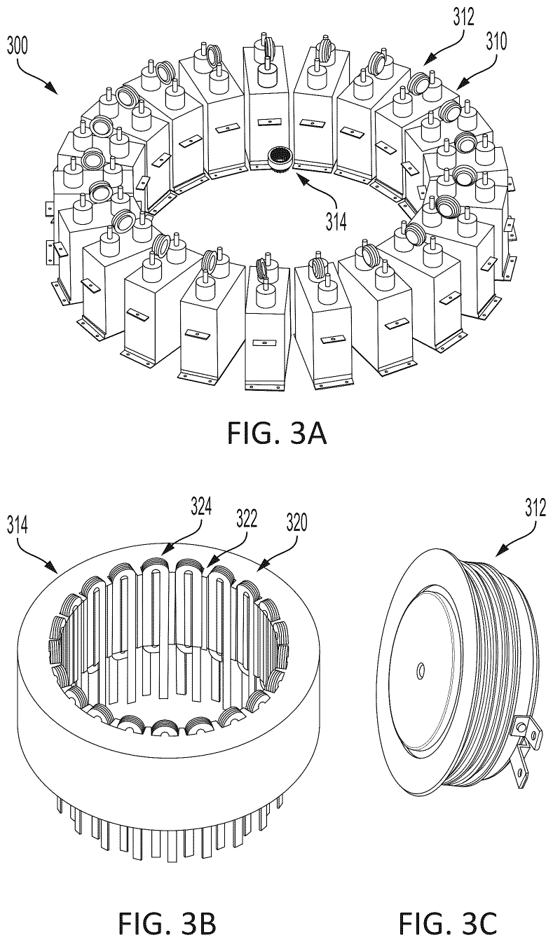

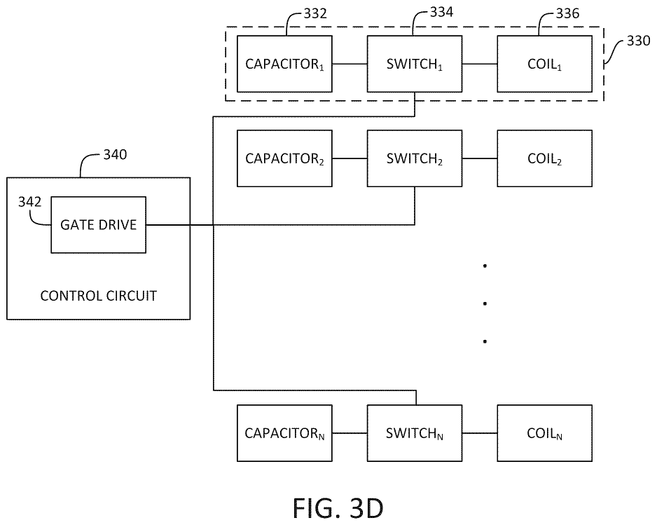

FIG. 3A schematically illustrates a magnetizer assembly 300 in accordance with some embodiments of the present disclosure. Magnetizer assembly 300 includes a set of capacitors 310. For example, each capacitor in the set of capacitors 310 may be configured to be charged up to a high voltage (e.g., thousands of volts). Magnetizer assembly 300 further includes a set of switches 312 electrically coupled to the set of capacitors 310. The set of switches 312 when activated may be configured to electrically couple the stored energy in the set of capacitors 310 to a magnetizing fixture 314 by completing a circuit between the set of capacitors 310 and a corresponding set of coils included as part of the magnetizing fixture 314. For instance, each switch in the set of switches 312 may be electrically coupled to a corresponding capacitor in the set of capacitors and a conductor (e.g., a busbar, not shown) coupled to a coil in the set of coils included in magnetizing fixture 314. When the switch is activated (e.g., closed), energy stored in the coupled capacitor may be discharged via the conductor to the set of coils, thereby creating a strong magnetic field within the magnetizing fixture 314. In some embodiments, magnetic fixture 314 may be configured to magnetize a polar anisotropic ring magnet.

Upon activating a switch in the set of switches 312, the energy in the coupled capacitor(s) may oscillate between the capacitor(s) and the coil(s) of the magnetizing fixture 314, causing a sinusoidally oscillating and decaying magnetic field. For instance, while a positive pulse of current passed through the coil may generate a first magnetic field to magnetize a magnet when present in the magnetizing fixture 314, a following negative pulse of current passed through the coil may generate a second (opposite) magnetic field, which may demagnetize the magnet. Accordingly, to effectively operate as a magnetizer, it may be desired to use only the first positive pulse of the oscillating current to energize the set of coils in the magnetizing fixture 314 prior to cutting the current off. Additionally, due to the relatively small amount of copper (or other conducting metal) included in the set of coils, it may be advantageous to keep the duration of the current pulse as short as possible to, for example, avoid overheating the coils during magnetization.

In some embodiments, the set of switches 312 may be implemented as a set of thyristors, with each thyristor in the set of thyristors being electrically coupled to a corresponding capacitor in the set of capacitors 310 as shown in FIG. 3A. An example thyristor is shown in more detail in FIG. 3C. Thyristors may be particularly effective switches because of their high current capacity, short switching time, and ability to stop conducting (i.e., block voltage) when the current tries to reverse direction. Although not shown in FIG. 3A, it should be appreciated that magnetizer assembly 300 may further include a baseplate on which the set of capacitors 310 are mounted, busbars or other conductors configured to couple the set of switches 312 to the set of coils in magnetizing fixture 314, and various other support structure for the magnetizer assembly 300. Additionally, it should be appreciated that magnetizer assembly 300 may include a controller (e.g., a control circuit) configured to control activation of the set of switches 312, a circuit to charge the capacitors 310, and a circuit to discharge the capacitors 310 after a magnetization pulse is generated. As described in further detail below, in some embodiments, a controller may be configured to activate all switches in the set of switches at the same time or substantially the same time, such that all arc-segments of a ring magnet present in the magnetizing fixture 314 are magnetized at the same time. In some embodiments, magnetizer assembly 300 may further include a cooling device configured to cool the set of coils following a pulse of magnetizing current. For instance, the cooling device may be an air or liquid cooled device arranged proximate to the set of coils in the magnetizer assembly 300, such that the cooling device draws heat away from the coils in the set of coils.

FIG. 3B schematically illustrates a magnetizing fixture 314, in accordance with some embodiments of the present disclosure. As shown, the magnetizing fixture 314 may include a core 320 and a set of teeth 322. In some implementations, the number of teeth in the set of teeth 322 may be equal to the number of poles in a ring magnet to be magnetized when placed in magnetizing fixture 314. In some embodiments, the core 320 may be configured to provide structural strength and high thermal conductivity to magnetizing fixture 314, while reducing (e.g., minimizing) electrical conductivity. For instance, the core 320 may comprise a ferromagnetic metal material (e.g., iron, magnetic steel, slightly magnetic steel, such as stainless steel grade 304)), which has high thermal conductivity. When such materials is used for core 320, lamination may be used to minimize eddy-currents within core 320 that tend to repel magnetic flux. The inventor has recognized that at typical field strengths used by magnetizer designed in accordance with the techniques described herein, the ability of core 320 to conduct magnetic flux is limited. Accordingly, in some embodiments, the core 320 may comprise a non-magnetic material, such as plastic, a polymer, a fiber-filled polymer, or stainless steel grade 316.

Magnetizing fixture 314 may further include a set of coils 324 (e.g., one or more coils) arranged on the set of teeth 322. For instance, the set of coils 324 may comprise copper wire (e.g., flat copper wire) wound around all or a subset of teeth 322 of the core 320. In the example magnetizing fixture 314 shown in FIG. 3B, the set of coils 324 is arranged on alternating teeth in the set of teeth 322, such that the number of coils in the set of coils 324 is half the number of teeth 322. The inventor has recognized that arranging the set of coils on alternating teeth of the core 320 may reduce coupling between adjacent coils, which may enable a circuit including a single coil (or a small number (e.g., two) of coils electrically coupled in series) to operate more independently from its neighboring coils. As described in more detail below, dividing the core 320 into segments that can be operated independently may enable shorter current pulses, which may reduce the risk of coil overheating during magnetization. Additionally, independent operation of circuits for each segment of the core 320 that include, for example, a capacitor, a thyristor, and a coil, may be better able to account for manufacturing variances of thyristors (or other switches), which may result in the thyristors turning on at slightly different times, even when controlled to turn on at the same time. Although the example shown in FIG. 3B shows coils arranged on every other tooth of the core 320, it should be appreciated that some embodiments may include coils arranged on every tooth of the core 320 to, for example, improve a copper packing factor inside of magnetizing fixture 314. In some embodiments, the set of coils 324 may be potted into the slots between the teeth 322, for example, using an epoxy. When the magnetizer assembly 300 is controlled to provide a pulse of current through each coil in the set of coils, a large magnetic field may be generated inside of magnetizing fixture 314 which may embed or “freeze” the magnetic field in the magnetic material of the magnet placed inside of the magnetizing fixture 314, thereby creating a permanent magnet. When the magnetizing fixture 314 is configured to magnetize a ring magnet with a magnetic field having a shape that approximates a Halbach array, the resulting magnet may be a Halbach array ring magnet.

FIG. 3D is a block diagram showing some components of a magnetizer assembly (e.g., magnetizer assembly 300), in accordance with some embodiments of the present disclosure. The magnetizer assembly shown in FIG. 3D includes a set of magnetization circuits 330, each of which includes a series connected capacitor 332 (e.g., from a set of capacitors 310), switch 334 (e.g., a thyristor in the set of switches 312) and a coil 336 (e.g., in the set of coils 324). As shown in FIG. 3D, the magnetizer assembly may include N magnetization circuits 330, which may correspond to different segments of a magnet to be magnetized using the magnetization assembly. Magnetizer assembly further includes a control circuit 340 including a gate drive 342. Control circuit 340 may be configured to use gate drive 342 to trigger all of the switches 334 simultaneously such that the corresponding capacitors 332 associated with the switches 334 are electrically coupled to the corresponding coils 336 within a set of magnetization circuits 330 at substantially the same time.

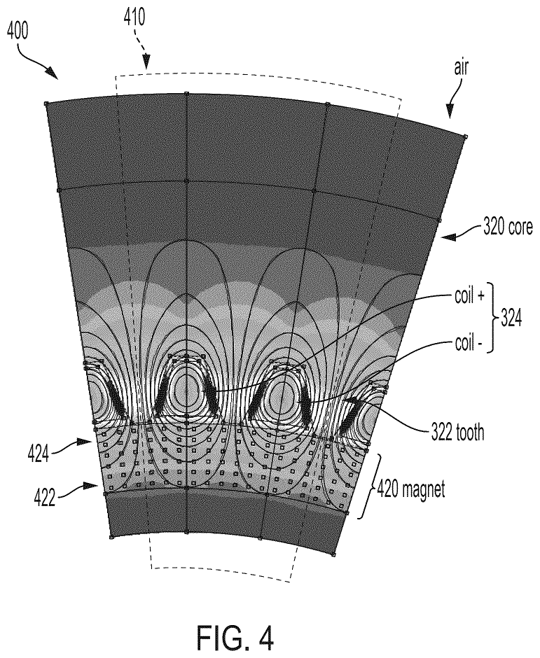

FIG. 4 schematically illustrates a process for magnetizing a ring magnet when placed in a magnetizing fixture (e.g., magnetizing fixture 314) in accordance with some embodiments of the present disclosure. In particular, FIG. 4 illustrates a cross-section 400 through a portion of the magnetizing fixture and a portion of a magnet 420 placed within the magnetizing fixture. As shown, the magnetizing fixture includes a core 320 having teeth 322 protruding toward the magnet 420. The core 320 including teeth 322 are configured to conduct magnetic flux generated by the magnetizer to complete the flux path. Core 320 may be made of any suitable material including, but not limited to, a magnetic material (e.g., a laminated ferromagnetic material) or a non-magnetic material. In some embodiments, a laminated metal is used to reduce eddy-currents in the core 320, which may otherwise have a “screening” effect on the magnetic flux. The laminations may be at least somewhat insulated from each other by, for example, creating an oxide layer and/or bonding the lamination layers with a non-conductive adhesive. The magnetizing fixture further includes a set of coils 324 arranged on teeth 322. In the example shown in FIG. 4, the envelope of the cross-section of the coils 324 has a trapezoidal shape. It should be appreciated, however, that envelope of the cross-section of the coils 324 may be square or may take any other shape. Additionally, the envelope of the cross section of all of the coils 324 in the set of coils need not be the same shape. For example, the set of coils may include coils that alternate between parallel sided and trapezoidal shaped coils in cross section.

FIG. 4 includes field lines that represent the magnetic field generated by the coils 324 when a peak current is provided through the coils. As shown, each coil 324 may include a negative terminal on one side of the tooth on which the coil is arranged and a positive terminal on the other side of the tooth on which it is arranged. Current flowing along the coil 324 in and out of the illustrated diagram in FIG. 4 results in a repeating “U-shaped” pattern of magnetic flux, where the flux is substantially radial at each pole of the magnet, the flux is substantially tangential between each pole of the magnet, and the poles have alternating polarity. In some embodiments, at peak current, the magnetic field at the “weak side” of the magnet (e.g., the interior diameter of the magnet 420) may be approximately 2.5 Tesla, approximately 3 Tesla, or approximately 4 Tesla.

The inventor has recognized and appreciated that conventional magnetizers used to magnetize Halbach ring magnets are unable to sufficiently magnetize such magnets (e.g., according to the magnetization specifications described above) due in part to the design limitations of such magnetizers. Accordingly, such magnetizers may only be capable of partially magnetizing ring magnets relative to a theoretical maximum magnetization. Such partially magnetized ring magnets may not perform (e.g., as a portion of a robot motor) as well as it could were it more strongly magnetized. As an example, a Halbach array has a strong magnetic field side and a weak magnetic field side. When the strong magnetic field side is on the outside diameter of the magnet, it can be particularly difficult to sufficiently magnetize the inside part of the magnet with a magnetizer placed adjacent to the outer diameter of the magnet, especially when the magnet radial thickness is substantial. To enable the magnetic field generated by the magnetizing fixture 314 to deeply penetrate the magnet and sufficiently magnetize the magnetic material near the inside diameter of the magnet, very high currents in the coils of the magnetizing fixture 314 may need to be used. However, as described above, the very high current may also need to be provided as a short pulse to prevent the coils from overheating. Some embodiments of the present disclosure relate to a magnetizer configured to generate a high current in the coils for a short period of time during magnetization to maximize the strength of the magnetic field generated, while staying within thermal limits of the coils. Such a magnetizer may be capable of magnetizing a Halbach ring magnet to have a surface magnetic field within 30%, 20%, 15%, 10%, 5%, or 1% of its theoretical maximum field strength.

Some conventional magnetizers configured to magnetize a ring magnet attempt to magnetize the entire magnet at once by coupling the coils in series, which results in both high resistance and inductance in the magnetizing fixture leading to a low natural frequency of the system and therefore a long duration current pulse to provide sufficient magnetization of the ring magnet. The long duration current pulse may result in overheating of the coils if the current used is too high. However, reducing the current leads to a reduction in the magnetic field generated by the magnetizing fixture. Using fewer turns on each coil and/or wiring the coils in parallel may reduce the inductance and resistance allowing for a shorter current pulse, but at the expense of a higher current being required through the switches (e.g., thyristors) of the magnetizing fixture. Although the switches themselves could be wired in parallel, small manufacturing variations between the switches may lead to differences in their turn-on times, which can damage the switch that turns on first. The inventor has recognized and appreciated that magnetizing arc-segments around the circumference of a ring magnet using individually controllable circuits, each of which is coupled to a single coil or small group of coils may be advantageous to maximize the strength of the magnetic field applied to the magnet, while taking into consideration the thermal limitations of the coils.

In the portion of the magnetizing fixture and magnet shown in FIG. 4, a segment 410 includes one coil and two poles of the magnet 420 (i.e., one pole in the middle of segment 410 and two half poles on the left and right sides of segment 410). Although only a single segment 410 is shown in FIG. 4, it should be appreciated that the segment 410 shown in FIG. 4 may repeated as a set of segments around the circumference of the magnet 420 present in the magnetizing fixture. Each segment in the set of segments may include a single coil or multiple coils (e.g., two coils) electrically coupled in series or parallel. The coil(s) included in the segment may be electrically coupled to a single switch (e.g., a single thyristor) via a conductor (e.g., a busbar), which in turn may be coupled to one or more capacitors in a set of capacitors, as described, for example, in FIG. 3A. In this way, each segment may be individually controlled by its own magnetization circuit. Because each magnetization circuit is configured to drive a single coil or a small number of coils, the capacitance and inductance in such a circuit is considerably less than in conventional magnetizers that attempt to use one magnetization circuit to magnetize the entire ring magnet. The lower capacitance and inductance in the magnetization circuit results in a natural frequency of the oscillating current to be higher when the switch is activated, which results in a shorter current pulse in the segmented design compared with the unsegmented design. As described herein, the use of a shorter current pulse reduces the risk that the coils will overheat during magnetization.

As described herein, a Halbach press mold may be used to align grains of a magnetic powder to a desired orientation. Aligning the grains of magnetic powder during the press operation predisposes the ring magnet to accept the magnetization of the ring magnet with the same magnetic flux pattern (i.e., a Halbach flux pattern) when the ring magnet is magnetized in a magnetizing fixture (e.g., magnetizing fixture 314). When placed in the magnetizing fixture the ring magnet should be rotated or “clocked” within the magnetizing fixture correctly based on the aligned grain structure of the ring magnet and the configuration of the magnetizing fixture. In some embodiments, the clocking can be achieved by inclusion of a mark added on the ring magnet during, or subsequent to, the press operation, and the mark on the ring magnet can be aligned with a corresponding mark on the magnetizing fixture prior to magnetization. The inventor has recognized that it may also be possible to clock the ring magnet correctly in the magnetizing fixture by lightly magnetizing the ring magnet prior to placement of the magnet in the final magnetizing fixture. For instance, the ring magnet may first be magnetized to a first field strength (e.g., lightly) using a first magnetization fixture and then the ring magnet may be magnetized to a second field strength (e.g., strongly) using a second magnetization fixture, with the second field strength being is greater than the first field strength. When the lightly magnetized magnet is placed in the second magnetization fixture, it may tend to rotate to the correct position within the second magnetization fixture, as described below.

The first magnetization fixture may be different than the second magnetization fixture. For instance, the first magnetization fixture may include a set of permanent magnets arranged to magnetize the ring magnet with a Halbach magnetic field pattern, whereas the second magnetization fixture may include a set of coils in accordance with the techniques described herein, wherein magnetization using the set of coils further magnetizes the ring magnet with a Halbach magnetic field pattern but at a higher field strength. First magnetizing the ring magnet to a first field strength (e.g., lightly) prior to full magnetization may enable the ring magnet to be aligned or “clocked” correctly in the second magnetization fixture since the slightly magnetized ring magnet will tend to rotate to a desired position within the second magnetization fixture. Dithering the magnet in rotation after placing the slightly magnetized ring magnet in the second magnetization fixture may help overcome friction and more precisely align the magnet in the second magnetization fixture prior to magnetizing the ring magnet with the second magnetization fixture.

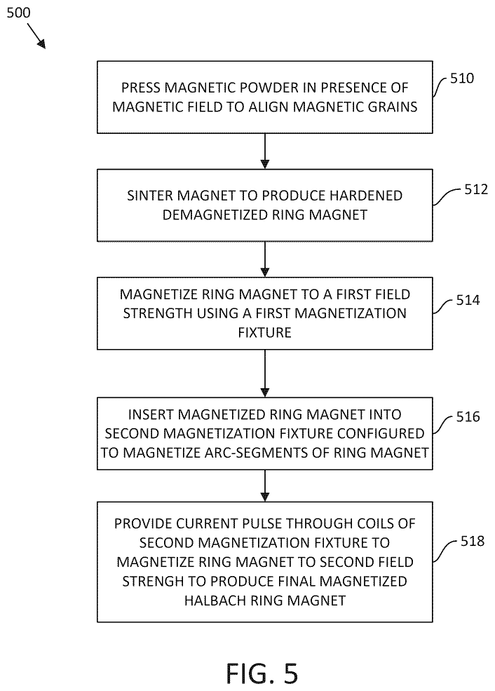

FIG. 5 illustrates a process 500 for magnetizing a ring magnet in accordance with some embodiments. Process 500 may begin in act 510, where magnetic powder is pressed into a mold (e.g., a press mold) in the presence of a magnetic field. For a Halbach ring magnet, a Halbach press mold may be used to align the grains of the magnetic powder in a desired orientation to form a green compact. Aligning the grains of magnetic powder during the press operation predisposes the ring magnet to accept the final magnetization with the same magnetic flux pattern. Process 500 then proceeds to act 512, where the green compact is sintered to harden the magnet with the magnetic grains aligned in the desired Halbach orientation. The sintering process demagnetizes the ring magnet due to the high temperatures used. As discussed above, to ensure that the ring magnet is properly aligned in the final magnetization fixture to accept magnetization with the desired flux pattern, it may be advantageous to first magnetize the ring magnet to a lower field strength than will be used for the final magnetization. Accordingly, process 500 proceeds to act 514, where the demagnetized ring magnet formed after sintering is magnetized to a first field strength using a first magnetization fixture. In some embodiments, the first magnetization fixture may be configured to apply a low intensity DC magnetic field of the desired magnetic field pattern. The first magnetization fixture may enable a user to rotate the magnet in the fixture to help align the magnet to its preferred position within the fixture. For instance, the first magnetization fixture configured to magnetize an outward-facing Halbach ring magnet (e.g., for use in an inrunner motor) may be implanted as an inward-facing Halbach ring magnet with the same number of poles as the ring magnet to be magnetized. In some embodiments, the second magnetization fixture used to perform a final magnetization of the ring magnet may also be used as the first magnetization fixture. In such embodiments, a low voltage may be applied across each capacitor in the fixture to generate a current in the corresponding coils that is far less than used for final magnetization. In this way, the second magnetization fixture may magnetize the ring magnet to the first field strength prior to final magnetization to a second field strength greater that the first field strength.

Process 500 then proceeds to act 516, where the ring magnet magnetized to the first field strength is inserted into a second magnetization fixture (e.g., magnetizer assembly 300) configured to magnetize arc-segments of the ring magnet. For instance, the magnetizer shown and described in connection with FIGS. 3A-4 may be used as the second magnetization fixture. Because the ring magnet has been magnetized to a first field strength in accordance with its preferred magnetization direction, the magnet may self-clock in the second magnetization fixture prior to final magnetization. When the second magnetization fixture is used for magnetizing the ring magnet to a first field strength and a second field strength, act 516 may be omitted. Process 500 then proceeds to act 518, where each of the arc-segments of the ring magnet is simultaneously magnetized by providing a current pulse through the coils of the second magnetization fixture associated with the respective arc-segments using individually controllable magnetization circuits of the second magnetization fixture, as described herein. Magnetization of the individual arc-segments results in a Halbach ring magnet that has been magnetized to a second field strength. Such a multi-pole Halbach ring magnet may be used, for example, as a portion of a rotor in an electric motor for a robot actuator. It should be appreciated that acts 510-514 may not be strictly necessary if, for example, a magnet magnetized to a first magnetic field and having a desired magnetic flux pattern is available (commercially or otherwise). In such a case, the magnetized magnet may be inserted into a magnetizer designed in accordance with the techniques described herein and magnetized to produce a final magnetized multi-pole Halbach ring magnet.

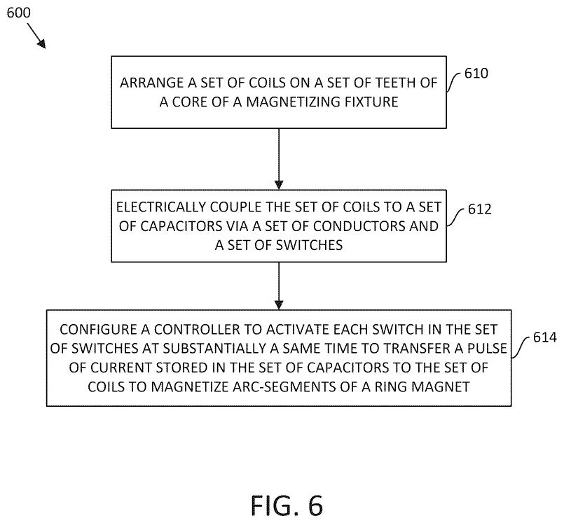

FIG. 6 illustrates a process 600 for manufacturing a magnetizer, in accordance with some embodiments of the present disclosure. Process 600 may begin in act 610, where a set of coils are arranged on a set of teeth of a core of a magnetizing fixture. Arranging the set of coils on the set of teeth may involve winding the coils around all or a subset of teeth, casting the coils in the slots between the set of teeth, or using some other suitable technique to arrange the set of coils on the set of teeth within the magnetizing fixture. In some embodiments, the coils may be pre-wound or pre-cast prior to arranging the set of coils on the set of teeth, and the pre-formed coils may be slid over the set of teeth and fixed to the core of the magnetizing fixture by, for example, potting the coils with a thermally conductive epoxy.

Process 600 may then proceed to act 612, where the set of coils is electrically coupled to a set of capacitors via a set of conductors and a set of switches. For instance, as described herein, busbars may be used to couple individual coils (or small groups of coils) in the set of coils to a single switch (e.g., a single thyristor) to form an individually controllable magnetization circuit for the coupled coil(s). Activating the switch in a single magnetization circuit may result in a current pulse being provided to the coil(s) coupled to that magnetization circuit without providing a current pulse to coil(s) coupled to other magnetization circuits in the magnetizing fixture. In some embodiments, each switch may be coupled to a single or multiple capacitors. In some embodiments, the capacitors may be controlled independently to, for example, facilitate safe operation (e.g., a short circuit in capacitor would not necessarily propagate to the other capacitors), for energy equalization (e.g., the capacitors could be charged to slightly different voltage levels to compensate for slightly varying capacitances), and to enable adjustment of timing (e.g., the voltages applied could be individually adjusted so that the magnetization current pulses end more synchronously).

Process 600 may then proceed to act 614, where a controller (e.g., control circuity including, for example, timing circuitry) may be configured to activate the switch in each magnetization circuit at substantially the same time. Activating the switches at substantially the same time may result in all arc-segments of the magnet being simultaneously magnetized via their individual magnetization circuits within the magnetizing fixture, while taking into account manufacturing variances in the switches in the set of switches (e.g., different thyristor turn on times). For instance, as described herein, activating the switches may result in a pulse of electrical charge being transferred from a charged up capacitor (or set of charged up capacitors) to an individual coil (or small group of coils) used to magnetize an arc-segment of the magnet. By activating all of the coils in the set of coils at substantially the same time, a strong magnetization of a ring magnet may be achieved.

A number of implementations have been described. Nevertheless, it will be understood that various modifications may be made without departing from the spirit and scope of the disclosure. For example, as described above, although the example embodiments described and pictured herein are for magnetizing outward-facing Halbach ring magnets, it should be appreciated that similar techniques may be used to magnetize inward-facing Halbach ring magnets.

1. A magnetizer for magnetizing a ring magnet, the magnetizer comprising:
a set of capacitors;
a core comprising a set of teeth;
a set of coils arranged on the set of teeth;
a set of conductors, each conductor in the set of conductors being electrically coupled to a coil in the set of coils; and
a set of switches electrically coupled between a conductor in the set of conductors and one or more capacitors in the set of capacitors, wherein each switch in the set of switches is configured to be controlled independently of other switches in the set of switches.

2. The magnetizer of claim 1, wherein the set of switches comprises a set of thyristors and/or the set of conductors comprises a set of busbars.

3. (canceled)

4. The magnetizer of claim 1, further comprising:
a controller configured to activate each switch in the set of switches at substantially a same time.

5. The magnetizer of claim 4, wherein activating the switch electrically couples the one or more coupled capacitors in the set of capacitors coupled thereto to its corresponding coil in the set of coils.

6. (canceled)

7. (canceled)

8. The magnetizer of claim 1, wherein the set of coils are arranged on alternating teeth in the set of teeth.

9. The magnetizer of claim 1, wherein the set of coils are potted into slots of the core between the set of teeth using an epoxy.

10. (canceled)

11. (canceled)

12. The magnetizer of claim 1, wherein
the core comprises a set of segments, and
each segment of the set of segments includes at least one coil in the set of coils.

13. The magnetizer of claim 12, wherein a first segment of the set of segments includes at least two coils electrically coupled in series.

14. The magnetizer of claim 12, wherein each segment of the set of segments includes a single coil of the set of coils and is associated with a single capacitor of the set of capacitors.

15. The magnetizer of claim 12, wherein each segment of the set of segments includes a single coil of the set of coils and is configured to magnetize a portion of a ring magnet having more than one pole when present in the magnetizer.

16. (canceled)

17. The magnetizer of claim 1, wherein the set of capacitors are electrically coupled in parallel.

18. (canceled)

19. The magnetizer of claim 1, wherein the core is ring-shaped.

20. A method of magnetizing a ring magnet using a magnetizer, the method comprising:
magnetizing a set of arc-segments of a ring magnet when the ring magnet is arranged in the magnetizer,
wherein magnetizing the set of arc-segments comprises simultaneously activating a set of switches to deliver a pulse of current through a set of coils of the magnetizer, each switch in the set of switches being coupled to a respective coil in the set of coils to form an independently controllable circuit including the switch and the coil.

21. (canceled)

22. (canceled)

23. The method of claim 20, further comprising:
pressing magnetic powder in a fixture in a presence of a magnetic field to generate a green compact having magnetic grains aligned in a desired magnetic flux pattern;
sintering the green compact to form a hardened ring magnet; and
orienting the hardened ring magnet in the magnetizer based on the alignment of the magnetic grains in the hardened ring magnet and a configuration of the magnetizer.

24. The method of claim 23, wherein orienting the hardened ring magnet in the magnetizer comprises:
magnetizing the hardened ring magnet to a first field strength in a first magnetization fixture to generate a first magnetized ring magnet having the desired magnetic flux pattern; and
placing the first magnetized ring magnet in a second magnetization fixture configured to magnetize the first magnetized ring magnet to a second field strength greater than the first field strength,
wherein orienting of the hardened ring magnet in the magnetizer is facilitated by the magnetic flux pattern of the first magnetized ring magnet and a configuration of the second magnetization fixture.

25. (canceled)

26. The method of claim 24, wherein orienting of the hardened ring magnet in the magnetizer is further facilitated by dithering a position of the first magnetized ring magnet within the second magnetization fixture.

27. (canceled)

28. (canceled)

29. The method of claim 20, wherein magnetizing the set of arc-segments comprises magnetizing the set of arc-segments such that magnetic material at an inner diameter of the ring magnet is magnetized to at least 2.5 Tesla.

30. A method of manufacturing a magnetizer for magnetizing a ring magnet, the method comprising:
electrically coupling a set of coils arranged on a set of teeth of a core to a set of capacitors via a set of conductors and a set of switches, wherein
each conductor in the set of conductors is electrically coupled to a coil in the set of coils,
each switch in the set of switches is electrically coupled between a conductor in the set of conductors and one or more capacitors in the set of capacitors, and
each switch is independently controllable such that current is provided from the one or more capacitors coupled to the switch to an individual conductor in the set of conductors.

31-40. (canceled)

41. The method of claim 30, wherein
the core comprises a set of segments, and
the method further comprises arranging at least one coil in the set of coils in each segment of the set of segments.

42. The method of claim 41, wherein arranging at least one coil in the set of coils in each segment of the set of segments comprises arranging in a first segment of the set of segments at least two coils electrically coupled in series.

43-48. (canceled)
